(19) United States
(12) Patent Application Publication
(10) Pub. No.: US 2009/0028996 A1
(43) Pub. Date: Jan. 29, 2009

(54) METHODS FOR REDUCING FOOD INTAKE AND CONTROLLING THE WEIGHT OF ANIMALS

(75) Inventors: Ryan Michael Yamka, Topeka, KS (US); Kim Gene Friesen, Carthage, IN (US); William David Schoenherr, Hoyt, KS (US); Lauren Jay Kats, Topeka, KS (US)

Correspondence Address: COLGATE-PALMOLIVE COMPANY, 909 RIVER ROAD, PISCATAWAY, NJ, 08855, US

(73) Assignee: Hill's Pet Nutrition, Inc., TOPEKA, KS (US)

(21) Appl. No.: 12/161,610

(22) PCT Filed: Jan. 23, 2007
(86) PCT No.: PCT/US07/60882

§ 371 Date: Jul. 21, 2008

Related U.S. Application Data
(60) Provisional application No. 60/761,301, filed on Jan. 23, 2006.

(51) Int. Cl. A23K 1/18; A23K 1/16; A23K 1/14

(52) U.S. Cl. 426/2; 426/120; 426/87; 426/656

(57) ABSTRACT

Methods for reducing food intake by and controlling the weight of an animal by feeding the animal a composition comprising a food intake reducing amount or a weight controlling amount of a soluble fiber.

This application claims benefit of U.S. Provisional No. 60/761,301 filed Jan. 23, 2006 which is hereby incorporated by reference in its entirety for all purposes.

### BACKGROUND OF THE INVENTION

1. Field of the Invention This invention relates generally to methods for feeding animals and particularly to methods for reducing food intake by animals and controlling the weight of animals.

2. Description of the Related Art

Animals considered overweight and/or obese have increased in number such that it is now estimated that, in the U.S., between 25% and 40% of companion animals are considered overweight or obese. An animal is considered overweight if it weighs more than 10% above its ideal body weight, and obese if it weighs more than 15% above its ideal body weight. An animal has an ideal body weight if the animal's ribs can be felt, but not seen. Obesity in animals is implicated in increased risk of diabetes mellitus, arthritis, pancreatitis, hepatic lipidosis, orthopedic disorders, cardiovascular disease, respiratory ailments, hip dysplasia, liver disease, gastrointestinal disorders, and skin problems.

Animals such as canines and felines have been the subjects of numerous dieting schemes and exercise regimens ultimately ineffective in controlling body weight. Advances have been made in development of reduced calorie animal foods, low fat animal foods, increased nonsoluble fiber animal foods, low carbohydrate/high protein animal foods, and other foods marketed for weight control. Still, statistics indicate that as a whole, opportunities for improvement remain and further advances in the art are needed. There is, therefore, a need for new methods for reducing food intake by and controlling the weight of animals.

### SUMMARY OF THE INVENTION

The invention provides methods for reducing food intake by animals and methods of controlling the weight of animals by feeding the animals a composition comprising a food intake reducing or weight controlling amount of soluble fiber.

The invention also provides an article of manufacture comprising a package containing a composition comprising a food intake reducing amount and/or a weight controlling amount of soluble fiber and a means for communicating information about or instructions for feeding the composition to an animal to reduce food intake and/or control weight. The communicating means is preferably attached to or enclosed in the package.

The invention also provides compositions comprising a food intake reducing amount and/or a weight controlling amount of soluble fiber.

The invention also provides a kit comprising a first package containing a food composition, a second package containing a fiber containing composition comprising a food intake reducing amount and/or a weight controlling amount of soluble fiber, and optionally a means for communicating information about or instructions for adding the fiber containing composition to the food composition and feeding the resulting fiber enriched food composition to an animal to reduce food intake and/or control weight.

The invention further provides a means for communicating information about or instructions for feeding a food composition comprising a food intake reducing and/or weight controlling amount of soluble fiber to an animal to reduce food intake and/or control weight, the means comprising a label, brochure, advertisement, package insert, computer readable digital or optical medium, audio presentation, visual presentation, or one or more pages on a website, containing the information or instructions.

Additional or alternative advantages and benefits of the method of the present invention will be apparent to one skilled in the art from reading this specification.

### DETAILED DESCRIPTION OF THE INVENTION

In one aspect, the present invention provides methods for reducing food intake by an animal. The methods comprise administering to the animal a composition comprising a food intake reducing amount of at least one soluble fiber. In another aspect, the invention provides methods for controlling the weight of an animal. The methods comprise administering to the animal a composition comprising a weight controlling amount of at least one soluble fiber.

The term “soluble fiber” means one or more fibers that are readily fermented in the large intestine, e.g., beet pulp, guar gum, chicory root, psyllium, pectin, blueberry, cranberry, squash, apples, oats, beans, citrus, barley, or peas.

Food intake reduction or control of an animal's weight due to feeding a composition comprising soluble fiber is by comparison with an otherwise similar composition that does not contain soluble fiber.

The phrase “reducing food intake” with respect to a factor means a reduction in the amount of food consumed relative to the amount of food consumed in the absence of that factor. A “food intake reducing amount” of soluble fiber is an amount of soluble fiber that, when consumed by an animal, is associated with a reduction in amount of food consumed.

The ability to control the weight of an animal by feeding to the animal a composition comprising a weight controlling amount of soluble fiber is relative to feeding an otherwise similar composition lacking only the weight controlling amount of soluble fiber. A “weight controlling amount” of soluble fiber is an amount of soluble fiber that, when consumed by an animal, is associated with improved weight control. In one embodiment, improved weight control allows an animal's ideal weight to be achieved over time.

In some embodiments, the invention provides a method for reducing food intake by an animal comprising adding to the composition a food intake reducing amount of soluble fiber. In one embodiment, the method comprises adding soluble fiber to a composition in an amount of at least about 0.3%, preferably at least about 1%, by weight on a dry matter basis. In other embodiments, the invention provides a method for controlling the weight of an animal by adding to the composition a weight controlling amount of soluble fiber. In one embodiment, the method comprises adding soluble fiber to a composition in an amount of at least about 0.3%, preferably at least about 1%, by weight on a dry matter basis.

The soluble fiber should be present in an amount that is not toxic or otherwise deleterious to the health of an animal consuming a normal quantity of the composition. In particular, the soluble fiber should be present at a concentration that does not cause undesirable effects on digestion, particularly long term effects lasting several days or longer. Undesirable effects on digestion can include constipation, poor stool quality, or diarrhea.

Suitable amounts of a soluble fiber useful for reducing food intake by an animal or controlling the weight of an animal are in a range of from about 0.3% to about 7%, preferably from about 0.5% to about 6%, more preferably from about 0.5% to about 3%, all by weight of the composition as measured on a dry matter basis.

The methods are useful for human or non-human animals. In various embodiments the animal is a vertebrate, for example, a fish, bird, reptile, or mammal. Animals can include humans, non-human animals such as non-human primates (e.g., monkeys, chimpanzees, etc.), companion animals (e.g., canine, feline, equine, etc.), livestock (e.g. porcine, ovine, bovine, caprine, etc.), laboratory animals (e.g., murine, rats, etc.), avian (e.g., domestic birds such as canaries, parrots, etc., commercial birds such as chickens, ducks, geese, turkeys, etc., and wild birds), rodents (e.g., murine, hamsters, guinea pigs, gerbils, rabbits, hedgehogs, ferrets, chinchillas, etc.) and wild, exotic and zoo animals (e.g., wolves, bears, cervine, piscine, etc.). Particularly among mammals, the animal can be a member of the order Carnivora, including without limitation canine and feline species.

The methods are useful for animals of any age, breed, and occupation, including adult animals, senior and geriatric animals, overweight animals, obese animals, and animals having a tendency toward obesity.

In a particular embodiment, the animal is a companion animal. A “companion animal” is an animal of any species kept by a caregiver as a pet or any animal of a variety of species that have been widely domesticated as pets, including dogs (Canis familiaris) and cats (Felis domesticus), whether or not the individual animal is kept solely or partly for companionship. Thus, companion animals includes working dogs, farm cats kept for rodent control, pet cats, pet dogs, ferrets, birds, reptiles, rabbits, and fish.

Compositions useful herein include foods, supplements, treats, and toys such as chewable and consumable toys. Some, but not all, supplements, treats, and toys are themselves foods. In some embodiments, the composition is nutritionally and/or organoleptically adapted for consumption by an animal of the order Carnivora. In other embodiments where the animal is a companion animal, the composition is nutritionally adapted for feeding to such an animal. A composition so adapted is referred to herein as a “pet food.”

In one embodiment, the composition is a food that comprises the following:
(a) at least about 0.3% soluble fiber; and
(b) at least one of the following:
   (i) from about 5% to about 70% (or from about 10% to about 70%, or from about 10% to about 60%) protein, and
   (ii) from about 2% to about 50% (or from about 5% to about 50%, or from about 5% to about 40%) fat.

In such an embodiment, the composition optionally further comprises at least one of the following:
(a) no greater than about 50% (or from about 5% to about 45%) carbohydrate.
(b) no greater than about 40% (or from about 1% to about 20%, or from about 1% to about 5.5%) dietary insoluble fiber, and
(c) no greater than about 15% (or no greater than about 10%, or from about 2% to about 8%) of one or more nutritional balancing agents known by those of skill in the art (e.g. fish oils, cereal grains, vitamins, minerals, etc.).

Specific suitable amounts for each component in a composition will depend on a variety of factors including, for example, the species of animal consuming the composition; the particular components included in the composition; the age, weight, general health, sex, and diet of the animal; the animal's consumption rate; and the like. Thus, the component amounts may vary widely, and may even deviate from the proportions set forth in this disclosure.

Protein, if present in a composition of the invention, may be supplied by any of a variety of sources, including plant sources, animal sources, or both. Animal sources include, for example, meat, meat by-products, seafood, dairy, eggs, etc. Meats include, for example, the flesh of poultry: fish; and mammals (e.g., cattle, pigs, sheep, goats, and the like). Meat by-products include, for example, lungs, kidneys, brain, livers, and stomachs and intestines (freed of all or essentially all their contents). The protein can be intact, almost completely hydrolyzed, or partially hydrolyzed.

Fat, if present in a composition of the invention, can be supplied by any of a variety of sources, including meat, meat by-products, fish oil, and plants. Plant fat sources include wheat, flaxseed, rye, barley, rice, sorghum, corn, oats, millet, wheat germ, corn germ, soybeans, peanuts, and cottonseed, as well as oils derived from these and other plant fat sources.

Carbohydrate, if present in a composition of the invention, may be supplied by any of a variety of sources, including oat fiber, cellulose, peanut hulls, beet pulp, parboiled rice, corn starch, corn gluten meal, and any combination of those sources. Grains supplying carbohydrate include, but are not limited to, wheat, corn, barley, and rice.

Insoluble fiber, if present in a composition of the invention, may be supplied by any of a variety of sources, including cellulose, whole wheat products, wheat oat, corn bran, flax seed, grapes, celery, green beans, cauliflower, potato skins, fruit skins, vegetable skins, peanut hulls, and soy fiber.

In instances when the composition is an animal's food, vitamins and minerals can be included in amounts required to avoid deficiency and maintain health. These amounts are readily available in the art. The Association of American Feed Control Officials (AAFCO) provides recommended amounts of such ingredients for dogs and cats. See Association of American Feed Control Officials. Official Publication, pp. 126-140 (2003). Vitamins useful as food additives include, e.g., vitamin A, vitamin B₁, vitamin B₂, vitamin B₆, vitamin B₁₂, vitamin C, vitamin D, vitamin E, vitamin H (biotin), vitamin K, folic acid, inositol, niacin, and pantothenic acid. Minerals and trace elements useful as food additives include calcium, phosphorus, sodium, potassium, magnesium, copper, zinc, choline, and iron salts.

The compositions of the present invention may further contain additives known in the art. Such additives should be present in amounts that do not impair the purpose and effect provided by the invention. Examples of additives include substances with a stabilizing effect, organoleptic substances, processing aids, and substances that provide nutritional benefits.

Stabilizing substances may increase the shelf life of the composition. Suitable examples can include preservatives, antioxidants, synergists and sequestrants, packaging gases, stabilizers, emulsifiers, thickeners, gelling agents, and humectants. Examples of emulsifiers and/or thickening agents include gelatin, cellulose ethers, starch, starch esters, starch ethers, and modified starches.

Additives for coloring, palatability, and nutritional purposes can include colorants, salts (including but not limited to sodium chloride, potassium citrate, potassium chloride, and other edible salts), vitamins, minerals, and flavoring. The amount of such additives in a composition typically is up to about 5% by weight (on a dry matter basis of the composition). Other additives can include antioxidants, omega-3 fatty acids, omega-6 fatty acids, glucosamine, chondroitin sulfate, vegetable extracts, herbal extracts, etc.

In one embodiment, the composition is a nutritional supplement comprising soluble fiber as defined herein. A supplement can be a food used with another food to improve the nutritive balance or performance of the total. Supplements include compositions that are fed undiluted as an addition to other foods, offered free choice with other parts of an animal's ration that are separately available, or diluted and mixed with an animal's regular feed to produce a complete food. Supplements may be in various forms including, for example, treats, kibbles, powders, liquids, syrups, pills, encapsulated compositions, etc.

In another embodiment, the composition is a treat comprising the soluble fiber. Treats include, for example, compositions that are given to an animal to eat during a non-meal time. Treats include, without limitation, dog bones, dog biscuits, cat treats, etc. Treats may be nutritional, wherein the composition comprises one or more nutrients, and may, for example, have a composition as described above for food. Non-nutritional treats encompass any other treats that are non-toxic.

In a further embodiment, the composition is a toy comprising the soluble fiber. Toys include play toys and chew toys. Toys for dogs include balls and artificial bones. The soluble fiber can form a coating on the surface of the toy or on the surface of a component of the toy, be incorporated partially or fully throughout the toy, or both. In one embodiment, the soluble fiber is orally accessible by the intended user. There are a wide range of suitable toys currently marketed. Toys useful according to this invention include both partially consumable toys (e.g., toys comprising plastic components) and fully consumable toys (e.g., rawhides and various artificial bones), toys for both human and non-human use, toys for companion, farm, and zoo animal use, and toys particularly for dog, cat, or bird use.

In preparing a composition of the present invention, the components of the composition are adjusted so that the soluble fiber is present in the composition in the desired amount, e.g., about 0.3% to about 7% on a dry matter basis. The soluble fiber can be distributed more or less homogeneously throughout the composition. The soluble fiber may be incorporated into the composition during processing of the formulation, such as during and/or after mixing of other components of the composition. Distribution of these components into the composition can be accomplished by conventional methods including standard mixing procedures. Alternatively, the soluble fiber can be present in whole or in part on surfaces of food pieces such as meat chunks, dry kibbles, or individual treats such as dog biscuits.

Compositions of the present invention (particularly foods) can be prepared in a dry form, for example using conventional processes. In one embodiment, dry ingredients, including animal protein sources, plant protein sources, grains, etc. are ground and mixed together. Moist or liquid ingredients, including fats, oils, animal protein sources, water, etc. are blended into the dry ingredients. The soluble fiber can be included as a dry ingredient or included as a moist or liquid ingredient, depending on the source of the soluble fiber. The resulting mixture can then be processed into kibbles or similar dry pieces. Kibble can be formed using an extrusion process in which the mixture of dry and wet ingredients is subjected to mechanical work at a high pressure and temperature, and forced through small openings and cut off into kibble by a rotating knife. The wet kibble is then dried and optionally coated with one or more topical coatings which may include, for example, flavors, fats, oils, powders, and the like. Kibble also can be made from the dough using a baking process, rather than extrusion, where the dough is placed into a mold before dry heat processing.

Compositions of the present invention (particularly foods) can be prepared in a canned or wet form, for example using conventional pet food processes. In one embodiment, ground animal (e.g., mammal, poultry, seafood, and/or fish) proteinaceous tissues are mixed with the other ingredients, including fish oils, cereal grains, other nutritionally balancing ingredients, and special purpose additives (e.g., vitamin and mineral mixtures, inorganic salts, cellulose and beet pulp, bulking agents, and the like). Water sufficient for processing may also be added. The wet form ingredients can be mixed in a vessel suitable for heating while blending the components. Heating of the mixture may be effected using any suitable manner, such as, for example, by direct steam injection or by using a vessel fitted with a heat exchanger. Following addition of the last ingredient, the mixture is heated to a temperature of about 50° F. to about 212° F. Temperatures outside this range are acceptable, but may be commercially impractical without use of other processing aids. When heated to an appropriate temperature, the material will typically be in the form of a thick liquid. The thick liquid is filled into cans. A lid is applied, and the container is hermetically sealed. The sealed can is then placed into conventional equipment designed to sterilize the contents. This is usually accomplished by heating to temperatures of greater than about 230° F. and for a time appropriate for the temperature used and the composition.

The soluble fiber can be incorporated into the wet food composition or mixed into the dry materials prior to forming the wet food composition.

Treats can be prepared by an extrusion or baking process similar to those described above for dry food. Other processes also may be used to either coat the soluble fiber on the exterior of existing treat forms, or inject it into an existing treat form.

The soluble fiber can be added during manufacturing of the composition, as indicated above, by a process of mixing or coating. In another embodiment, the soluble fiber is added to an animal's food by the person responsible for feeding the animal.

For this purpose, it is more convenient, and reduces risk of accidental over addition of the soluble fiber, to provide the soluble fiber in diluted or dispersed form in a suitable carrier such as vegetable oil or edible powder. A powder comprising the soluble fiber can be sprinkled on an animal's food immediately before feeding. Alternatively, a liquid comprising the soluble fiber can be drizzled or sprayed on the food. Such powder or liquid compositions are described herein as “fiber containing compositions.” They can be applied to the top of a serving of food and/or can be mixed into the food. The use of such fiber containing compositions to reduce food intake and/or control weight is an embodiment of the present invention.

A fiber containing composition as described above can be purchased independently of the food to which it is to be added; alternatively, such a composition or seasoning can be purchased together with the food in the form of a kit, for example a co-packaged kit. Such a kit can further include a label or package insert providing guidance or instructions as to suitable amounts of the fiber containing composition to be added to the food.

A food intake reducing amount and/or a weight controlling amount of the soluble fiber will generally be found in a range as provided herein, e.g., from about 0.3% to about 7%, from about 0.5% to about 6%, from about 0.5% to about 3%, by weight of the composition on a dry matter basis to which the soluble fiber is to be added.

In another embodiment of the invention, an article of manufacture comprises a package containing a composition comprising an intake reducing amount and/or a weight controlling amount of the soluble fiber as described herein. Any form of package appropriate to the nature of the composition can be used, including without limitation, a can, a jar, a pouch, a bag, a tube, a bag in a box, etc. The article of this embodiment further comprises a means for communicating information about or instructions for feeding the composition to an animal. The communicating means can be attached to or enclosed in the package. Any suitable form of communicating means can be employed, for example, a document such as a label, brochure, advertisement or package insert, a computer readable digital or optical medium such as a diskette or CD, an audio presentation, for example, on an audiotape or CD, or a visual presentation, for example on a videotape or DVD. The communicating means can refer to further information located elsewhere, such as on a website.

Such a communicating means, comprising for example, a document such as a label, brochure, advertisement or package insert, a computer readable digital or optical medium such as a diskette or CD, an audio presentation, for example, on an audiotape or CD, a visual presentation, for example, on a videotape or DVD, and/or one or more pages on a website, is itself a still further embodiment of the invention.

The method of the invention will be found especially beneficial in cases where the animal is, or has become, overweight or obese, or is rapidly gaining weight.

The present invention also includes the use of the compositions of the present invention for controlling the weight of an animal, and for reducing the food intake of an animal. The compositions of the present invention may also be useful for treating or preventing obesity in an animal. The compositions of the present invention may also be useful for the manufacture of pet foods, specifically, dog or cat foods.

All percentages expressed herein are on a weight by dry matter basis unless specifically stated otherwise.

This invention is not limited to the particular methodology, protocols, and reagents described herein because they may vary. Further, the terminology used herein is for the purpose of describing particular embodiments only and is not intended to limit the scope of the present invention. As used herein and in the appended claims, the singular forms “a,” “an,” and “the” include plural reference unless the context clearly dictates otherwise. Similarly, the words “comprise”, “comprises”, and “comprising” are to be interpreted inclusively rather than exclusively.

Unless defined otherwise, all technical and scientific terms and any acronyms used herein have the same meanings as commonly understood by one of ordinary skill in the art in the field of the invention. Although any methods and materials similar or equivalent to those described herein can be used in the practice of the present invention, the preferred methods, devices, and materials are described herein.

All patents, patent applications, and publications mentioned herein are incorporated herein by reference to the extent allowed by law for the purpose of describing and disclosing the compounds, processes, techniques, procedures, technology, articles, and other compositions and methods disclosed therein that might be used with the present invention. However, nothing herein is to be construed as an admission that the invention is not entitled to antedate such disclosure by virtue of prior invention.

### EXAMPLES

The invention can be further illustrated by the following examples, although it will be understood that these examples are included merely for purposes of illustration and are not intended to limit the scope of the invention unless otherwise specifically indicated.

### Example 1

This example demonstrates the effect of soluble fiber on food intake in adult cats. Sixty cats (10 per treatment) are allotted 1 of 6 food treatments in a 2×3 factorial arrangement as shown in Table 1: 0.5%, 1.0%, or 2.0% added soluble fiber in combination with 14% total fiber or 1.0%, 2.0%, or 4.0% added soluble fiber in combination with 24% total fiber. Cats are fed the experimental foods for 7 days to determine daily food intake. The results are shown in Table 2.

Referring to Table 2, adding soluble fiber to food containing 14% total fiber reduces average daily food intake (ADFI) in adult cats. ADFI is not decreased by the addition of 1% or more soluble fiber to food containing 24% total fiber.

TABLE I
Cat Food Composition*

| | Total Dietary Fiber | | | | | | |
|---|---|---|---|---|---|---|---|
| | 14% | | | | 24% | | |
| Soluble Fiber** | 0.5% | 1.0% | 2.0% | | 1.0% | 2.0% | 4.0% |
| Ingredient | | | | Ingredient | | | |
| Brewers Rice | 34 | 31.77 | 29.66 | Poultry Meal | 27.79 | 26.23 | 23.64 |
| Corn Gluten | 24 | 21.83 | 23.77 | Corn | 24.58 | 23.65 | 21.79 |
| Meal | | | | | | | |
| Low Ash Poultry | 21.13 | 23.20 | 22.55 | Corn Gluten | 19.49 | 20.55 | 22.11 |
| Meal | | | | Meal | | | |
| Cellulose | 8.02 | 6.64 | 4.04 | Cellulose | 17.49 | 14.57 | 8.8 |
| Corn | 3.4 | 3.4 | 3.4 | Beet Pulp | 2.95 | 7.3 | 15.96 |
| Grease | 1.675 | 3 | 2.57 | Water | 1.5 | 1.5 | 1.5 |
| Water | 1.5 | 1.5 | 1 | Pal Enhancer A | 1.5 | 1.5 | 1.5 |
| Soybean Mill | 1.5 | 1.5 | 1.5 | Soybean Oil | 1.45 | 1.45 | 1.45 |
| Run | | | | | | | |
| Pal Enhancer A | 1.2 | 1.2 | 1.2 | Potassium | 0.726 | 0.722 | 0.710 |
| | | | | Chloride | | | |
| Choline Chloride | 0.8 | 0.8 | 0.8 | Calcium Sulfate | 0.65 | 0.65 | 0.65 |
| Potassium | 0.681 | 0.7 | 0.713 | Pal Enhancer B | 0.5 | 0.5 | 0.5 |
| Chloride | | | | | | | |
| Pal Enhancer B | 0.5 | 0.5 | 0.5 | Choline Chloride | 0.44 | 0.44 | 0.44 |
| L-Carnitine | 0.45 | 0.45 | 0.45 | L-Carnitine | 0.44 | 0.44 | 0.44 |
| Calcium Sulfate | 0.4 | 0.4 | 0.4 | Glycerol | 0.2 | 0.2 | 0.2 |
| Salt | 0.25 | 0.25 | 0.25 | Taurine | 0.1 | 0.1 | 0.1 |
| Vitamin E | 0.2 | 0.2 | 0.2 | Preservative A | 0.07 | 0.07 | 0.07 |
| Vitamin Premix | 0.126 | 0.126 | 0.126 | Vitamin Premix | 0.067 | 0.067 | 0.067 |
| Taurine | 0.1 | 0.1 | 0.1 | Trace Mineral | 0.04 | 0.04 | 0.04 |
| | | | | Premix | | | |
| Trace Mineral | 0.05 | 0.05 | 0.05 | Preservative B | 0.01 | 0.04 | 0.01 |
| Premix | | | | | | | |
| Beet Pulp | 0 | 2.38 | 6.71 | | | | |
| Analyzed Results | | | | Analyzed Results | | | |
| Moisture | 8.77 | 5.31 | 3.45 | Moisture | 4.31 | 4.35 | 4.56 |
| Protein | 33.2 | 35.29 | 37.37 | Protein | 36.48 | 36.5 | 35.68 |
| Fat | 7.3 | 8.17 | 8.43 | Fat | 8.2 | 8.22 | 7.87 |
| Ash | 4.74 | 5.34 | 5.75 | Ash | 5.85 | 5.86 | 6.25 |
| Calcium | 0.87 | 1.01 | 1.06 | Calcium | 1.11 | 1.12 | 1.11 |
| Phosphorus | 0.76 | 0.83 | 0.85 | Phosphorus | 0.82 | 0.83 | 0.78 |
| Magnesium | 0.066 | 0.07 | 0.084 | Magnesium | 0.083 | 0.099 | 0.12 |
| Potassium | 0.65 | 0.7 | 0.72 | Potassium | 0.75 | 0.76 | 0.76 |
| Sodium | 0.31 | 0.33 | 0.34 | Sodium | 0.23 | 0.24 | 0.23 |
| Chloride | 0.71 | 0.75 | 0.77 | Chloride | 0.61 | 0.62 | 0.62 |
| Crude Fiber | 6.4 | 6.5 | 5.6 | Crude Fiber | 13.5 | 12.7 | 10.5 |
| Insoluble Fiber | 12.1 | 12.2 | 12.1 | Insoluble Fiber | 23.2 | 22.2 | 20.8 |
| Soluble Fiber** | 0.6 | 0.3 | 2.3 | Soluble Fiber** | 1.6 | 2.2 | 3.7 |
| Total Dietary | 12.7 | 12.5 | 14.4 | Total Dietary | 24.8 | 24.4 | 24.5 |
| Fiber | | | | Fiber | | | |

*Ingredients are As-Mixed; Nutrients are As-Fed
**Soluble fiber in top line is food as intended to be formulated, and in table as analyzed.

TABLE 2
Effect of Soluble Fiber Food Intake in Adult Cats

| | Total Dietary Fiber. % | | | | | |
|---|---|---|---|---|---|---|
| | 14% | | | 24% | | |
| Soluble Fiber, % | 0.5 | 1.0 | 2.0 | 1.0 | 2.0 | 4.0 |
| ADFI, g/day | 61.4 | 51.2 | 46.2 | 41.4 | 45.6 | 46.1 |

### Example 2

This example demonstrates the effect of soluble fiber on ad libitum food intake in adult cats. Twenty-one cats (7 per treatment) are allotted 1 of 3 food treatments: 0.5%, 1.0%, or 2.0% added soluble fiber in combination with 14% total dietary fiber (as shown in Table 1). Cats are fed the experimental foods for 30 days to determine if the food composition reduced daily food intake. The average daily food intake is averaged for days 0-7, 7-14, 14-21, and 21-30 of the study. The results are shown in Table 3.

Referring to Table 3, the results indicate that voluntary food intake is reduced in cats by adding soluble fiber to the diet. Numbers are presented as average daily food intake (grams per day).

TABLE 3
Effects of Soluble Fiber on Food Intake in Adult Cats (g/day)

| | Day 0-7 | Days 7-14 | Days 14-21 | Days 21-30 |
|---|---|---|---|---|
| 0.5% Soluble Fiber | 55.5 | 72.6 | 80.3 | 80.1 |
| 1.0% Soluble Fiber | 50.2 | 68.7 | 85.5 | 84.0 |
| 2.0% Soluble Fiber | 48.7 | 66.9 | 74.3 | 70.1 |

### Example 3

This example demonstrates the effect of soluble fiber on food intake in adult dogs. Thirty dogs (10 per treatment) are allotted 1 of 3 food treatments: 0.5%, 1.0%, or 2.0% added soluble fiber in combination with 12% total fiber, as shown in Table 4. Dogs are fed the experimental foods for 7 days to determine daily food intake. The results are shown in Table 5.

Referring to Table 5, the results indicate that voluntary food intake is reduced in dogs by adding soluble fiber to the diet.

TABLE 4
Dog Food Composition*

| Soluble Fiber** | 0.5% | 1.0% | 2.0% |
|---|---|---|---|
| Moisture | 6.1 | 8.14 | 7.63 |
| Protein | 18.77 | 18.32 | 17.95 |
| Fat | 14.44 | 13.89 | 14 |
| Ash | 4.49 | 4.24 | 4.52 |
| Calcium | 0.72 | 0.64 | 0.69 |
| Phosphorus | 0.6 | 0.55 | 0.56 |
| Magnesium | 0.1 | 0.11 | 0.12 |
| Potassium | 0.75 | 0.69 | 0.69 |
| Sodium | 0.19 | 0.17 | 0.18 |
| Chloride | 0.65 | 0.52 | 0.62 |
| Crude Fiber | 6.2 | 3.6 | 3.5 |
| Insoluble Fiber | 11.4 | 10.4 | 10.3 |
| Soluble Fiber** | 1.1 | 1 | 1.7 |
| Total Dietary | 12.5 | 11.4 | 12 |
| Fiber | | | |

*On an As-Fed Basis.
**Soluble fiber in top line is food as intended to be formulated, and in table as analyzed.

TABLE 5
Effect of Soluble Fiber Food Intake in Adult Dogs

| | Total Dietary Fiber, % | | |
|---|---|---|---|
| | 12 | | |
| Soluble Fiber, % | 0.5 | 1.0 | 2.0 |
| ADFI, g/day | 258 | 201 | 176 |

In the specification, there are disclosed typical preferred embodiments of the invention and, although specific terms are employed, they are used in a generic and descriptive sense only and not for purposes of limitation, the scope of the invention being set forth in the following claims. Obviously many modifications and variations of the present invention are possible in light of the above teachings. It is therefore to be understood that within the scope of the appended claims the invention may be practiced otherwise than as specifically described.

What is claimed is:

1. A method for reducing food intake by an animal comprising administering to the animal a composition comprising a food intake reducing amount of at least one soluble fiber.

2. The method of claim 1 wherein the composition comprises a source of soluble fiber selected from the group consisting of beet pulp, guar gum, chicory root, psyllium, pectin, blueberry, cranberry, squash, apples, oats, beans, citrus, barley, peas, and combinations thereof.

3. The method of claim 1 or 2 wherein the composition comprises at least two sources of soluble fiber selected from the group consisting of beet pulp, guar gum, chicory root, psyllium, pectin, blueberry, cranberry, squash, apples, oats, beans, citrus, barley, and peas.

4. The method of any one of claims 1-3 wherein the soluble fiber comprises from about 0.3% to about 7% by weight of the composition on a dry matter basis.

5. The method of any one of claims 1-4 wherein the soluble fiber comprises from about 0.5% to about 6% by weight of the composition on a dry matter basis.

6. The method of any one of claims 1-5 wherein the soluble fiber comprises at least about 1% by weight of the composition on a dry matter basis.

7. The method of any one of claims 1-6 wherein the composition is nutritionally and/or organoleptically adapted for consumption by an animal of the order Carnivora.

8. The method of any one of claims 1-7 wherein the animal is feline or canine.

9. The method of any one of claims 1-7 wherein the composition is a dog or cat food.

10. The method of any one of claims 1-9 wherein the composition is a food supplement, a treat, or a toy.

11. The method of any one of claims 1-10 wherein the soluble fiber is diluted or dispersed in a powder or liquid carrier to form a food intake reducing composition, and the soluble fiber is added to the animal's food in the form of the fiber intake reducing composition.

12. A method for controlling the weight of an animal comprising feeding the animal a composition comprising a weight controlling amount of soluble Fiber.

13. The method of claim 12 wherein the composition is nutritionally and/or organoleptically adapted for consumption by an animal of the order Carnivora.

14. The method according to claim 12 or 13 wherein the animal is canine or feline.

15. The method according to any one of claims 12-14 wherein the composition comprises a source of soluble fiber selected from the group consisting of beet pulp, guar gum, chicory root, psyllium, pectin, blueberry, cranberry, squash, apples, oats, beans, citrus, barley, peas, and combinations thereof.

16. The method of any one of claims 12-15 wherein the composition comprises at least two sources of soluble fiber selected from the group consisting of beet pulp, guar gum, chicory root, psyllium, pectin, blueberry, cranberry, squash, apples, oats, beans, citrus, barley, and peas.

17. The method of any one of claims 12-16 wherein the soluble fiber comprises from about 0.3% to about 7% by weight of the composition on a dry matter basis.

18. The method of any one of claims 12-17 wherein the soluble fiber comprises at least about 1% by weight of the composition on a dry matter basis.

19. A kit comprising:
a first package containing a food composition; and
a second package containing a fiber containing composition comprising a food intake reducing amount and/or a weight controlling amount of soluble fiber.

20. The kit of claim 19 further comprising a means for communicating information about or instructions for adding the fiber containing composition to the food composition and feeding the resulting fiber enriched food composition to an animal to reduce food intake and/or control weight.

21. A means for communicating information about or instructions for feeding to an animal a food composition comprising soluble fibers in a food intake reducing amount and/or a weight controlling amount, the means comprising a label, brochure, advertisement, package insert, computer readable digital or optical medium, audio presentation, visual presentation, or one or more pages on a website containing the information or instructions.

22. An article of manufacture comprising:
a package containing a composition comprising a food intake reducing amount and/or a weight controlling amount of soluble fiber: and
a means for communicating information about or instructions for feeding the composition to an animal to reduce food intake and/or control weight, the means being attached to or enclosed in the package.

23. A food comprising:
(a) at least about 0.3% soluble fiber; and
(b) at least one of the following:
(i) from about 5% to about 70% protein, and
(ii) from about 2% to about 50% fat.

24. The food of claim 23 further comprising no greater than about 50% carbohydrate.

25. The food of claim 23 or 24 comprising from about 5% to about 45% carbohydrate.

26. The food of any one of claims 23-25 comprising no greater than about 40% dietary insoluble fiber.

27. The food of any one of claims 23-26 comprising from about 1% to about 20% dietary insoluble fiber.

28. The food of any one of claims 23-27 comprising from about 1% to about 5.5% dietary insoluble fiber.

29. The food of any one of claims 23-28 comprising no greater than about 15% of one or more nutritional balancing agents.

30. The food of any one of claims 23-29 which is a dog food.

31. The food of any one of claims 23-29 which is a cat food.

32. The food of any one of claims 23-31 wherein the food is a food supplement, a treat, or a toy.

33. The food of any one of claims 23-32 wherein the soluble fiber is diluted or dispersed in a powder or liquid carrier to form a food intake reducing composition, and the soluble fiber is added to the animal's food in the form of the Fiber intake reducing composition.

34. A method of controlling the weight of an animal comprising feeding the animal an effective amount of the food of any one of claims 23-33.

35. A method for reducing the food intake of an animal comprising feeding the animal an effective amount of the food of any on of claims 23-33.

36. The use of the food of any one of claims 23-33 for controlling the weight of an animal.

37. The use of the food of any one of claims 23-33 for reducing the food intake of an animal.
